(19) United States
(12) Patent Application Publication
(10) Pub. No.: US 2008/0114670 A1
(43) Pub. Date: May 15, 2008

(54) SYSTEMS AND METHODS FOR A TRANSACTION VETTING SERVICE

(76) Inventor: Mark FRIESEN, Portland, OR (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 11/939,932

(22) Filed: Nov. 14, 2007

Related U.S. Application Data
(60) Provisional application No. 60/859,180, filed on Nov. 14, 2006.

(51) Int. Cl. G06Q 40/00

(52) U.S. Cl. 705/35

(57) ABSTRACT

An embodiment relates generally to a method of processing a financial transaction. The method includes receiving a requested transaction, where the requested transaction is transferring a sum of money or other assets from an originator to a receiver. The method also includes applying a set of rules to the requested transaction to vet the requested transaction, where the set of rules define the regulatory and legal compliance rules for the governing jurisdictions of the originator and receiver for a legal transaction. The method further includes obtaining a result from the application of the set of rules and approving the requested transaction in response to the result being passing all requirements of the set of rules.

### RELATED APPLICATION

This application stems from and claims priority to U.S. Provisional Application Ser. No. 60/859,180, entitled “Vetting-Based Funds-Transfer System and Methodology,” filed on Nov. 14, 2006, the disclosure of which is incorporated by reference herein in its entirety.

### FIELD

This invention relates to systems and methods for a transaction vetting service.

### DESCRIPTION OF THE RELATED ART

Currently, all fund transfers and payment systems ultimately use account numbers to identify source and destination accounts. For example, the Automated Clearinghouse Network (“ACH”) network is a network of over 12,000 banks and financial institutions that comply with the national ACH (NACHA) standard format of transferring funds and other assets electronically. Another example is Society for the Worldwide Interbank Financial Telecommunication (“SWIFT”) that is a cooperative organization that promulgates a messaging service for financial messages such as letters of credit, payments and securities transactions between member banks worldwide.

The use of the ACH and SWIFT networks made transferring funds rapid and easy. As a result, illegal activities such as money laundering, terrorist group funding, etc., also increased. Governments have passed laws such as the Patriot Act, Bank Secrecy Act, etc., to prevent and reduce these illegal activities. Governments may have agencies such as Office of Foreign Asset Control, Federal Deposit Insurance Corporation, Financial Crimes Network Enforcement, etc., to promulgate regulations to ensure financial institutions comply and enforce these goals.

A key proviso, generally, to comply with the numerous legal and regulatory rules is an identification and verification of the participants in the financial transaction. However, existing networks, for example ACH, do not have a mechanism to identify and verify the participants in a financial transaction. SWIFT can verify a recipient under special circumstances. Accordingly, the verification of the recipients has to be conducted manually at each financial institution. This increases the cost of compliance and also the cost of the transaction. Failure to comply with the existing legal and regulatory requirements can result in substantial fines.

Additionally, lobbying groups for Financial Institutions have successfully changed bills before the U.S. Congress that have limited their effectiveness (such as the online gaming act) by expressing to congress that existing transaction and settlement systems, such as ACH, have no ability to vet a financial transactions to the level of granularity required to make the law effective. Moreover, it is impossible using the existing systems to provide third-party approval or adjust the transaction amount.

### SUMMARY

An embodiment relates generally to a method of processing a financial transaction. The method includes receiving a requested transaction, where the requested transaction is transferring a sum of money or other assets from an originator to a receiver. The method also includes applying a set of rules to the requested transaction to vet the requested transaction, where the set of rules define the regulatory and legal compliance rules for the governing jurisdictions of the originator and receiver for a legal transaction. The method further includes obtaining a result from the application of the set of rules and

approving the requested transaction in response to the result passing all requirements of the set of rules.

Another embodiment pertains generally to a system for processing a financial transaction. The system includes a network configured to provide communication services and a plurality of financial institutions coupled to the network. The system also includes a transaction vetting service coupled to the network. The transaction vetting service is configured to receive a requested transaction from a first financial institution to a second financial institution from the plurality of financial institutions and to apply a set of rules to the requested transaction to vet the requested transaction. The transaction vetting service is also configured to obtain a result from the application of the set of rules and to approve the requested transaction in response to the result being passing all requirements of the set of rules.

Yet another embodiment relates generally to an apparatus for vetting transactions. The apparatus includes an interface module configured to couple with a communication medium and an internal database configured to store verification information. The apparatus also includes a rules database configured to store a plurality of rules, each rule specifying at least one condition for a legal transfer of money between financial institutions. The apparatus further includes a vetting processor configured to receive a requested transaction from a first financial institution to a second financial institution and to apply a set of rules from the rules database. The vetting processor can also obtain a result from the application of the set of rules. The vetting processor can also approve the requested transaction in response to the result passing all requirements of the set of rules.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 depicts an exemplary block diagram of a system in accordance with an embodiment;

FIG. 2 illustrates another exemplary block diagram of the transaction vetting service in accordance with various embodiments;

FIG. 3 shows an exemplary user interface in accordance with various embodiments;

FIG. 4 illustrates yet another exemplary flow diagram accordance with various embodiment; and

FIG. 5 depicts an exemplary flow diagram in accordance with various embodiments.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of financial systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments relate generally to systems and methods for a vetting based funds transfer transactions. More particularly, a transaction vetting service can be configured to ensure a proper, secure, and lawful transfer of money between two financial institutions. A user may submit a transaction request to the transaction vetting service. The user had previously registered with the transaction vetting service through the financial institution holding the funds. The financial institution can then provide the transaction vetting service with required information.

The transaction vetting service can then apply a vetting process to the requested transaction. The transaction vetting service can apply a set of rules to the requested transaction complies with any governing jurisdictions regulatory and legal requirements. The transaction vetting service can also determine the legality of the originator and receiver ends of the transaction. For example, the transaction vetting service can query third party databases, sources to verify the identities of the originator or receiver of the requested transaction if any information is missing from the requested transaction.

The transaction vetting service can allow the requested transaction to proceed after a successful determination from the vetting process. The transaction vetting service can also delay the requested transaction pending further vetting or stop the requested transaction in response to the vetting process returning a violation with any of the rules.

A simple example is purchasing wine online. It is legal in most states to purchase wine online if you meet the drinking age requirement. Currently, there is no way for an online seller of wine to verify the age of the buyer and the merchant must be fully aware of the laws in each state regarding online sales. The solution is to provide a vetting service that can, in this instance, verify three pieces of information—the person making the purchase is the owner of the account the funds are drawn from, the state that the funds are held (or the state the product is to be shipped to, depending on the specific law) and that the person is not younger than 21. The transaction vetting service provides for this vetting no matter the method of payment chosen.

Another example is the billing for medical services. The price charged to a consumer often depends on the patient's insurer. This price may not be known to the end-provider but is negotiated between the providers PPO and the insurer. Secondly, the provider will typically not know if a deductible was met or if certain services will be paid by the insurer. If the financial payment transaction, irrespective of the method of payment was sent to a transaction vetting service, the transaction could be price adjusted and also held pending final approval or if additional information is required from the provider to process the transaction.

Yet another example is the setting of spending limits based on the person approving the payment. Typically corporations set spending approval limits on their employees that have signing writes to an account. However, banks will explain that they cannot enforce these self-imposed limits. The transaction vetting service can enforce corporate rules based on single transaction amounts, per diem allowances, and even rules regarding the requirement of two officers to approve a transaction. Again, it is irrelevant what method of payment is used, and in this example it is also irrelevant what corporate account is used to make the disbursement—the transaction vetting service would recognize the account ownership and barring any specialized rules for the specific accounts would apply the general spending authorization rules for the corporation across all accounts.

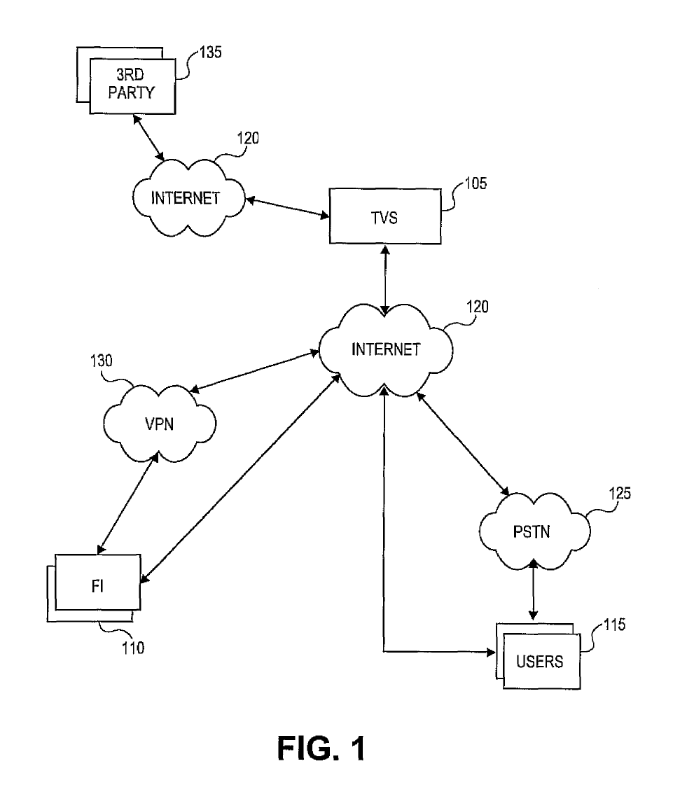

FIG. 1 illustrates an exemplary system 100 in accordance with various embodiments. It should be readily apparent to those of ordinary skill in the art that the system 100 depicted in FIG. 1 represents a generalized schematic illustration and that other components may be added or existing components may be removed or modified.

As shown in FIG. 1, the system 100 includes a transaction vetting service (labeled as “TVS” in FIG. 1) 105 coupled with financial institutions (labeled as “FI” in FIG. 1) 110 and users 115 through network 120 and PSTN network 125. The TVS 105 can be configured to apply a vetting process for a transaction requested by either a FI 110 or a user 115. The TVS 105 can apply a set of rules to the requested transaction to determine whether the requested transaction complies with any governing jurisdictions regulatory and legal requirements. The TVS 105 can also verify or authenticate the originator and receiver ends of the transaction through an internal database of account holders. In some embodiments, the internal database can contain biometric data for verification purposes. The TVS 105 can also query third party databases, sources, etc., to verify the identities of the originator or receiver of the requested transaction in the event that the internal database does not contain the necessary information.

The TVS 105 can allow the requested transaction to proceed after a successful determination from the vetting process. The TVS 105 can also delay the requested transaction pending further vetting or stop the requested transaction in response to the vetting process returning a violation with any of the rules.

The FI 110 can be banks, credit unions, or other similar financial institution. The FI 110 can forward requests for transactions and get results from vetting process of the TVS 105 through a variety of methods. For instance, the FI 110 can access the TVS 105 over the network 120 using secure transmissions protocols such as HTTPS or other forms of secure communication. Network 120 can be a combination of local area networks, wide area networks, Internet or combinations thereof. Alternatively, the FI 110 can couple with the TVS 105 using private networks such as virtual private network 130.

Account holders of FI 110 (or users 115) can access the TVS 105 by entering the physical location of a FI 110 and placing a requested financial transaction such as a money transfer, a payment, etc. Users 115 can also access the TVS 105 directly over the telephone network, PSTN 125. More particularly, in some embodiments, the TVS 105 can have service agents that can receive requests for financial transactions. The service agents can enter the information from the user 115 into the TVS 105 as the FI 110 to utilize the vetting process of the TVS 105.

In the instances where the requested information from the user 115 is insufficient, the TVS 105 can be configured to utilize third party databases, business information sources, and other electronic databases to search for the missing information. For example, a requested transaction may list a newly created business as a receiving account holder. The TVS 105 can be configured to search third party databases 135 such as state databases for incorporation information, Dun & Bradstreet™, Lexis-Nexis™ or other similar electronic databases for legitimate business entities. The TVS 105 can also access public record databases such as telephone directory databases, public record databases, etc., to verify the identities of individuals in the requested transaction.

In some embodiments, the verification of identities of the originator and receiver can involve several steps. The initial step is to verify the identity of the originator of the transaction. This can involve comparing biometric data from the originator with existing biometric data, the use of a digital certificate, or other established authentication procedure. The second step can be to verify that the originator has signing authority for the account. This can involve querying the responsible financial institution or checking against an internal secure database containing this information. The third step can be verifying the ownership or title on the originating account (which may be different than the authorized signatoree). The fourth step can be verifying the ownership of the receiving account.

The TVS 105 can be further configured to provide verification services. In certain embodiments, the TVS 105 can obtain biometric data at the time of the transaction (e.g., retinal eye scan, fingerprint scanner or similar biometric device coupled to a computer). The TVS 105 can also use information provided by the entity providing access to the services of the TVS 105.

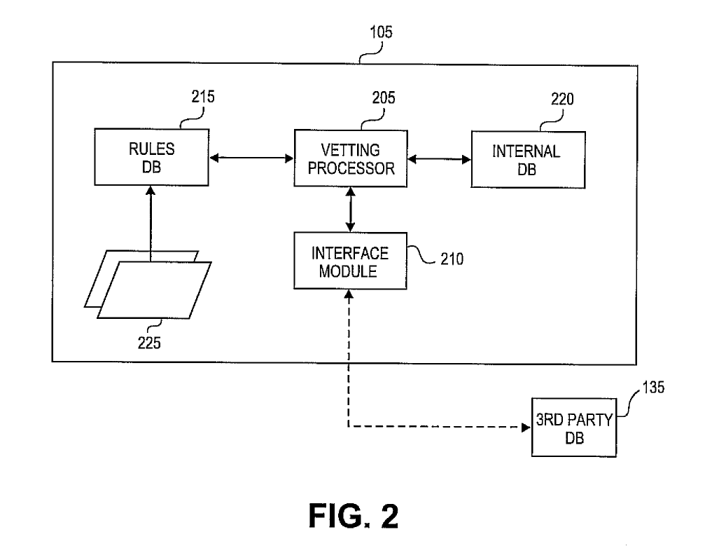

FIG. 2 illustrates a more detailed block diagram of the TVS 105 shown in FIG. 1 in accordance with various embodiments. It should be readily apparent to those of ordinary skill in the art that the block diagram depicted in FIG. 2 represents a generalized schematic illustration and that other components may be added or existing components may be removed or modified.

As shown in FIG. 2, the TVS 105 can comprise a vetting processor 205, an interface module 210, a rules database 215, and a verification database 220. The vetting processor 205 can be configured to provide the previously described and in greater detail below functionality of the TVS 105. The vetting processor 205 can be implemented as software application which then executes on a computing platform such as a server, mainframe, or other similar device.

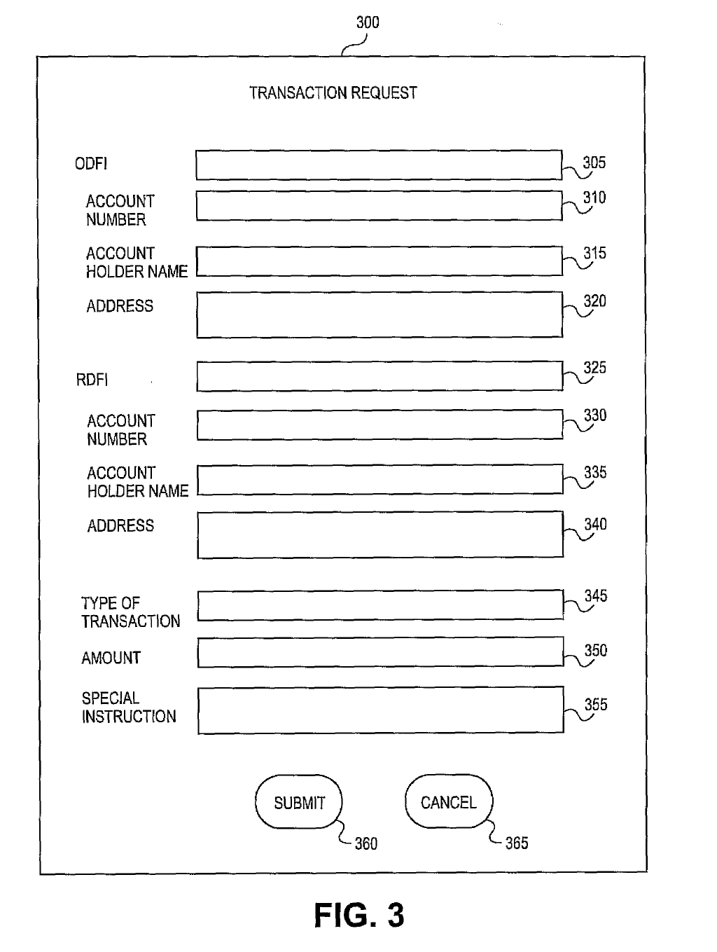

The vetting processor 205 can be configured to couple with the interface module 210. The interface module 210 can be configured to provide an interface for users to interact with the services of the TVS 105. For example, the interface module 210 can generate a log-in screen for FI 110 and/or users 115 to access the services of the TVS 105. The interface module 210 can also generate a transaction request user interface, as shown in FIG. 3.

FIG. 3 illustrates an exemplary user interface 300 in accordance with various embodiments. It should be readily apparent to those of ordinary skill in the art that the user interface (“UI”) 300 depicted in FIG. 3 represents a generalized schematic illustration and that other components may be added or existing components may be removed or modified.

As shown in FIG. 3, the UI 300 can comprise numerous text entry fields. In general, UI 300 can be divided into three sections: originating depository financial institution (“ODFI”) information, a receiving depository financial institution (RDFI”) information, and transaction information. The ODFI can comprise an ODFI text box 305, an account number text box 310, an account holder name 315, and an address text box 320.

The OFDI text box 305 can be configured for the identifying number of the financial institution to be entered. The account number text box 310 can be configured for the originating account number in the financial institution. The account holder name 315 can be configured for the name of the account holder. The address text box 320 can be configured for the address of the account holder. Other possible text entry boxes can also be social security number (when allowable by law), insurance membership number, national identity number for individuals that have citizenship outside of the US, birthday or other similar identifying event.

The RDFI text box 325 can be configured for the identifying number of the financial institution receiving the funds. The account number text box 330 can be configured for the receiving account number in the financial institution. The account holder name 335 can be configured for the name of the account holder. The address text box 340 can be configured for the address of the account holder. Other possible text entry boxes can also be social security number (when allowable by law), insurance membership number, national identity number for individuals that have citizenship outside of the US, birthday or other similar identifying event.

The transaction type box 345 can be configured for selection of the type of transfer. For example, the transaction can be transfer or a payment. The amount text field 350 can be configured to hold the amount of money, bonds, stocks, or other assets being transferred. The special instruction text entry box 355 can be configured for any instructions or conditions to be set for the transaction. For example, this box 355 could hold an instruction to hold the transaction until a package is delivered.

The submit button 360 can be configured to transfer the filled information of the UI 300 to the vetting processor 205 in response to being activated. The cancel button 365 can be configured to discard any information in the UI 300 in response to being activated.

In many instances the information received will not include much of the data explained above. For example an ACH transaction will typically only contain account numbers and an amount. Any additional information required must be obtained through other means such as the third party databases 135 and/or other sources.

Returning to FIG. 2, the interface module 210 can also be configured to provide an interface to the available third party databases 135 as required by the vetting processor 205.

The vetting processor can be coupled to a rules database (labeled as “RULES DB” in FIG. 2) 215. The rules database 215 can be configured to store the rules to analyze a requested transaction. More particularly, the rules database 215 can contain the actions, decision trees, and process flows based to ensure compliance with all governing laws, regulations and conditions. The governing laws and regulations can be domestic origin and/or foreign origin. Accordingly, the rules stored in the rules database 215 are derived from all applicable laws and regulations 225.

One example of a rule set can be directed for on-line alcohol sales. As such, the rule set would include rules such as: verify the recipient is over the legal drinking age limit; no alcohol sales to the following states: x, y, z; determine the tax rate for the receiving state; determine any federal taxes, etc.

The rules database 215 can also allow for any type of transactions. A rule set can be defined for corporate events such as authorization from a third party or for purchasing events such as authorizing payment upon delivery. Accordingly, the use of the rules database 215 can provide great flexibility in the application of the services of the TVS 105.

The vetting processor 205 can be further coupled to a verification database (labeled as “VERIFICATION DB in FIG. 2) 220. The verification database 220 can contain information regarding the account holders of the FI 110. The users 115 can directly or indirectly register their information with their respective FI 110. In some embodiments, the verification database 220 can also include biometric information of the account holders for verification purposes. As an illustrative example, the vetting processor 205 can be configured to receive a transaction request from a FI 110. The vetting processor 205 can determine the applicable rules that apply to the transaction request based on the OFDI and the RDFI. The vetting processor 205 can then apply those selected rules to the transfer request to vet the transaction request. In some embodiments, the selected rules may specify the granularity of the verification process as previously described. As part of the vetting process, the vetting processor 205 can verify the identities of the parties using the verification database. If any information is missing, the vetting processor 205 can utilize third party databases 135 to search for the missing information.

The vetting processor 205 can then be configured to return at least four possible results. The vetting processor 205 can approve the transaction. The vetting processor 205 can also report the transaction if required by a selected rule. The vetting processor 205 can also hold the transaction as requested by the special instruction. The vetting processor 205 can further stop the transaction and notify the appropriate authorities.

Returning to the hold condition, the vetting processor 205 can be configured to hold a transaction based on instructions or conditions. For example, the vetting processor 205 can hold transaction until a delivery of a product. The conditions for releasing a hold can be based on multiple conditions. The multiple conditions can also specify that the amount of money or other assets being transferred or the receiving party can be change.

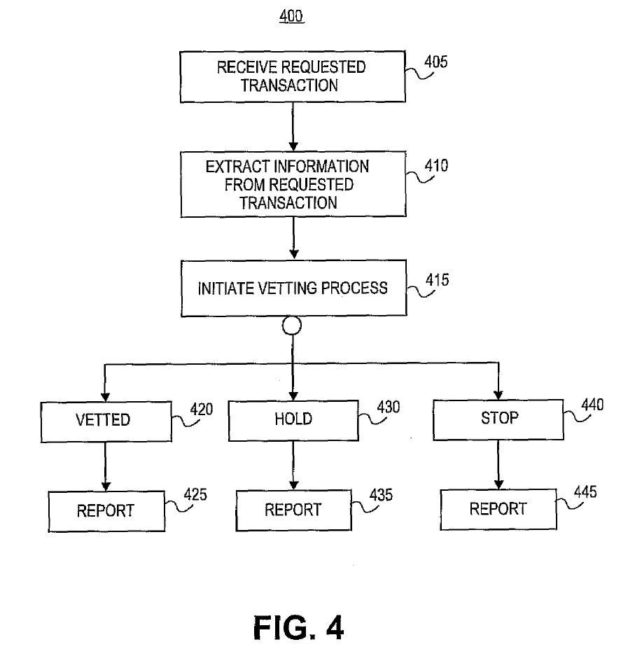

FIG. 4 shows a flow diagram 400 executed by the vetting processor 205 in accordance with various embodiments. It should be readily apparent to those of ordinary skill in the art that the flow diagram 400 depicted in FIG. 4 represents a generalized schematic illustration and that other steps may be added or existing steps may be removed or modified.

As shown in FIG. 4, in step 405, the vetting processor 205 can be configured to receive a transaction request. More particularly, the vetting processor can be forwarded a transaction request UI 300 through the interface module 210 from a FI 110 or a user 115.

In step 410, the vetting processor 205 can be configured to extract the information from the transaction request UI 300 and temporarily buffer this information. In some instances, the special instructions can include additional information such as list of items purchased, are there restrictions on the release of funds based on other conditions or a third party approval. The special instruction information provides necessary information for certain transactions. These specialized instructions may or may not be included in the transaction record. However these specialized instructions may be included in the rules database 215, an additional database, or looked up in a third party database.

In step 415, the vetting processor 205 can use the ODFI and RDFI identifying numbers to select which rules from the rules database 215 to apply to the transaction request. The vetting processor 205 can then apply the selected rules to the transaction request.

The vetting processor 205 can then be configured to return at least three possible results. In step 420, the vetting processor 205 can approve the transaction. In some instances, in step 425, the vetting processor 205 can also be required to report the transaction as required by one of the selected rules. In step 430, the vetting processor 205 can also hold the transaction as requested by the special instruction. Subsequently, if required by the selected rules, in step 435, the vetting processor 205 can also be required to report the transaction. In step 440, the vetting processor 205 can further stop the transaction and notify the appropriate authorities in step 445.

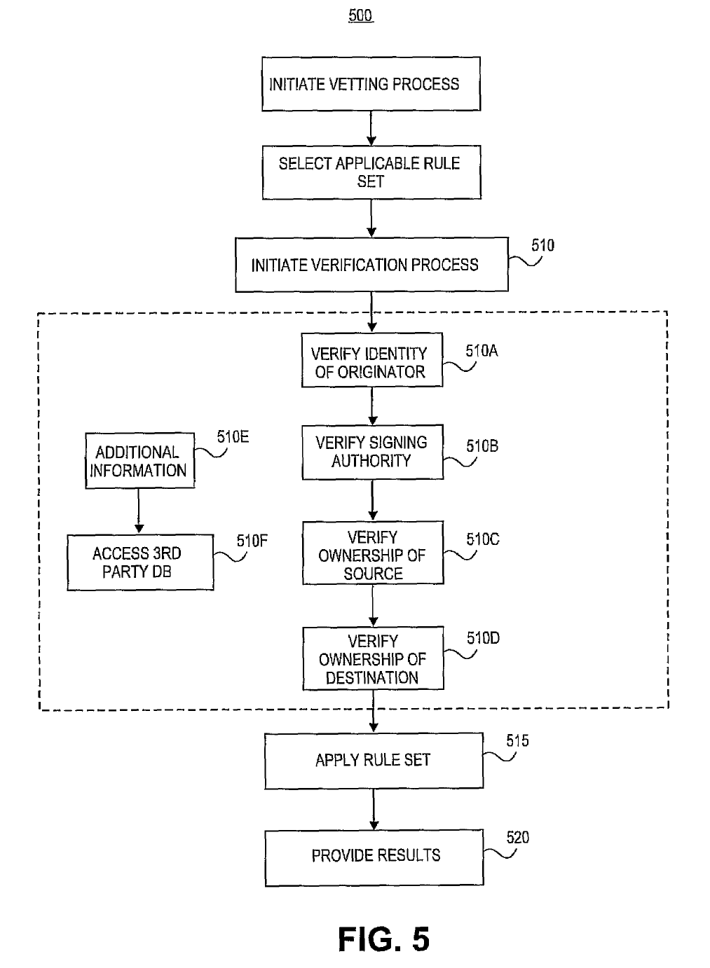

FIG. 5 illustrates a flow diagram 500 executed by the vetting processor 205 in accordance with various embodiments. It should be readily apparent to those of ordinary skill in the art that the flow diagram 500 depicted in FIG. 5 represents a generalized schematic illustration and that other steps may be added or existing steps may be removed or modified.

Flow diagram 500 can expand on the processing involved with step 415 of flow diagram 400. As shown in FIG. 5, in step 505, the vetting processor 205 can be configured to determine which rules that applies to the transaction request. For example, by examining the identifying numbers of the OFDI and RDFI, the vetting processor 205 can determine the transaction request is a domestic or international transaction. The selected rules can also identify the granularity of the verification process used by the vetting processor 205.

In step 510, the vetting processor can be configured to initiate the verification process. As shown in FIG. 5, the verification process can comprise at least four steps. In step 510A, the vetting processor 205 can be configured to verify the identity of the originator of the transaction request. The vetting processor 205 can use a variety of methods to verify the identity such as biometric data, a password or personal identification number associated with the source account, a birthday, an insurance card number or other similar identifying characteristic. The vetting processor 205 can use any provided verification data to compare with any stored verification data in the verification database 220. Subsequently, the vetting processor 205 can be configured to buffer the result from the verification of the identity of the originator.

In the event that the verification database 220 does not have any pre-stored verification data, the vetting processor 205 can be configured to search third party databases 135 for the missing information as noted by steps 510E, 510F.

In some embodiments, vetting the identity of the originator may include information provided within the transaction record such as encryption based on a user digital certificate or including a pin number, etc, or it may be obtained directly from the originator by the vetting service at the time the transaction is initiated, or the transaction can be held and the verification happens at a later time.

In step 510B, the vetting processor 205 can be configured to verify the signing authority of the originator of the transaction request. More specifically, the vetting processor 205 can check the verification database 205 to see the originator has signing authority. The vetting processor 205 can also be configured to query the responsible financial institution for this information. Subsequently, the results are temporarily buffered by the vetting processor 205.

In step 510C, the vetting processor 205 can be configured to verify the originator of the transaction request is the owner or has title of the source account. More particularly, the vetting processor 205 can check the verification database 205 to see the originator is the owner of the source account. The vetting processor 205 can also be configured to query the responsible financial institution for this information. Subsequently, the results are temporarily buffered by the vetting processor 205.

In step 510D, the vetting processor 205 can be configured to verify the ownership of the destination account. More particularly, the vetting processor 205 can check the verification database 205 to see whether the name of the receiver is the owner of the destination account. The vetting processor 205 can also be configured to query the responsible financial institution of the destination account for this information. If this information is not provided by the verification database 220 or the responsible financial institution, the vetting processor can search the third party databases 135 for the missing information as noted by steps 510E, 510F. Subsequently, the results are temporarily buffered by the vetting processor 205.

In step 515, the vetting processor 205 can then apply the selected rules to the transaction request along with the results of the verification. In step 520, the vetting processor 205 can then provide the previously described result.

Once all parties are known any additional rules required to complete the transaction can then be implemented. These may include an OFAC check of the participants, verification of the legality of the transaction, appropriate reporting, etc.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of processing a financial transaction, the method comprising:
receiving a requested transaction, wherein the requested transaction is transferring a sum of money or other assets from an originator to a receiver;
applying a set of rules to the requested transaction to vet the requested transaction, wherein the set of rules define the regulatory and legal compliance rules for the governing jurisdictions of the originator and receiver for a legal transaction;
obtaining a result from the application of the set of rules; and
approving the requested transaction in response to the result being passing all requirements of the set of rules.

2. The method of claim 1, the method further comprising:
approving the transaction in response to the result being a suspicious transaction; and
notifying a governing government authority that the requested transaction is suspicious.

3. The method of claim 1, the method further comprising:
approving the transaction in response to the result being passing requirements of the set of rules; and
notifying a governing government authority of the requested transaction as required by a rule in the set of rules.

4. The method of claim 1, the method further comprising placing a hold on the requested transaction in response to a result being that additional information is required.

5. The method of claim 1, the method further comprising placing a hold the requested transaction until at least one subsequent event occurs.

6. The method of claim 5, the method further comprising modifying the sum of money or other assets in response to the occurrence of the at least one subsequent event.

7. The method of claim 5, the method further comprising modifying the receiver to a second receiver.

8. The method of claim 1, further comprising transmitting a stop transaction message in response to a violation of the set of rules, wherein the stop transaction message describes a reason for the stop transaction message.

9. The method of claim 8, further comprising notifying any governing government authorities of the stop transaction message and the requested transaction.

10. A system for processing a financial transaction, the system comprising:
a network configured to provide communication services;
a plurality of financial institutions coupled to the network; and
a transaction vetting service coupled to the network, wherein the transaction vetting service is configured to receive a requested transaction from a first financial institution to a second financial institution from the plurality of financial institutions; to apply a set of rules to the requested transaction to vet the requested transaction; to obtain a result from the application of the set of rules; and to approve the requested transaction in response to the result being passing all requirements of the set of rules.

11. The system of claim 10, wherein the transaction vetting service is further configured to approve the requested transaction in response to the result being passing all requirements of the set of rules.

12. The system of claim 10, wherein the transaction vetting service is further configured to approve the transaction in response to the result being a suspicious transaction and to notify a governing authority that the requested transaction is suspicious.

13. The system of claim 10, wherein the transaction vetting service is further configured to approve the transaction in response to the result being passing requirements of the set of rules and to notify a governing authority of the requested transaction as required by a rule in the set of rules.

14. The system of claim 10, wherein the transaction vetting service is further configured to place a hold on the requested transaction in response to a result being that additional information is required.

15. The system of claim 10, wherein the transaction vetting service is further configured a hold the requested transaction until at least one subsequent event occurs.

16. The system of claim 15, wherein the transaction vetting service is further configured to modify an amount associated with the requested transaction in response to the occurrence of the at least one subsequent event.

17. The system of claim 15, wherein the transaction vetting service is further configured to modify a receiver associated with the requested transaction to a second receiver in response to the occurrence of the at least one subsequent event.

18. The system of claim 10, wherein the transaction vetting service is further configured to transmit a stop transaction message in response to a violation of the set of rules, wherein the stop transaction message describes a reason for the stop transaction message.

19. The system of claim 18, wherein the transaction vetting service is further configured notifying any governing government authorities of the stop transaction message and the requested transaction.

20. An apparatus for vetting transactions, the apparatus comprising:
an interface module configured to couple with a communication medium;
an internal database configured to store verification information;
a rules database configured to store a plurality of rules, each rule specifying at least one condition for a legal transfer of money or other assets between financial institutions; and
a vetting processor configured to receive a requested transaction from a first financial institution to a second financial institution; to apply a set of rules from the rules database; to obtain a result from the application of the set of rules; and to approve the requested transaction in response to the result being passing all requirements of the set of rules.

21. The apparatus of claim 20, wherein the transaction vetting service is further configured to approve the requested transaction in response to the result being passing all requirements of the set of rules.

22. The apparatus of claim 18, wherein the transaction vetting service is further configured to approve the transaction in response to the result being a suspicious transaction and to notify a governing authority that the requested transaction is suspicious.

23. The apparatus of claim 20, wherein the transaction vetting service is further configured to approve the transaction in response to the result being passing requirements of the set of rules and to notify a governing authority of the requested transaction as required by a rule in the set of rules.

24. The apparatus of claim 20, wherein the transaction vetting service is further configured to place a hold on the requested transaction in response to a result being that additional information is required.

25. The apparatus of claim 20, wherein the transaction vetting service is further configured a hold the requested transaction until at least one subsequent event occurs.

26. The system of claim 20, wherein the transaction vetting service is further configured to modify an amount associated with the requested transaction in response to the occurrence of the at least one subsequent event.

27. The system of claim 20, wherein the transaction vetting service is further configured to modify a receiver associated with the requested transaction to a second receiver in response to the occurrence of the at least one subsequent event.

28. The apparatus of claim 20, wherein the transaction vetting service is further configured to transmit a stop transaction message in response to a violation of the set of rules, wherein the stop transaction message describes a reason for the stop transaction message.
